(19) United States
(12) Patent Application Publication
(10) Pub. No.: US 2024/0331034 A1
(43) Pub. Date: Oct. 3, 2024

(54) OUTTURN-BASED RESOURCE ALLOCATION

(71) Applicant: Sharegain Ltd, London (GB)

(72) Inventor: Benjamin Alexander Smith, London (GB)

(21) Appl. No.: 18/191,827

(22) Filed: Mar. 28, 2023

(51) Int. Cl. G06Q 40/03; G06Q 20/38; G06Q 40/06

(52) U.S. Cl. CPC G06Q 40/03; G06Q 20/389; G06Q 40/06

(57) ABSTRACT

In examples, an event associated with generation of resource output has an associated entitlement date and a generation date. Accordingly, a set of virtual accounts with which the resource was associated on the entitlement date is determined, which are thus entitled to generated resource output on the generation date. In examples, resource information is determined for each virtual account that indicates resource units that were on-loan or available for grant to another user/virtual account on the entitlement date. Additionally, a change in resource information is evaluated, thereby determining, for each account, resource output that was generated due to the event. Accordingly, resource output for the event is allocated (e.g., and subsequently processed, for example to generate another resource grant) based on a proportion of resource units that were on-loan or available to grant as of the entitlement date.

### BACKGROUND

In examples, a virtual account associated with a user and a given resource may have one or more corresponding units of that resource, where a resource generation event associated with the resource may result in additional or fewer units of the resource and/or of an alternative resource. Additionally, there may be instances where an election by the user affects resource generation output, which may thus further complicate resource management, especially in instances where multiple users (e.g., each having an associated virtual account) may each provide a potentially varying election. Thus, managing allocation of such additional or fewer resource units may be challenging for these and other reasons.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to outturn-based resource allocation. In examples, an indication of an event associated with generation of resource output is received. That event may have an associated entitlement date and a resource generation date. Accordingly, a set of virtual accounts with which the resource was associated on the entitlement date is determined, which are thus entitled to the resource output that is generated on the generation date. In examples, resource information is determined for each of the virtual accounts, which indicates a number of resource units that were on-loan or available for grant to another user/virtual account as of the entitlement date.

Additionally, a change in resource information (e.g., between the generation date and a date prior to the generation date) is evaluated for each virtual account, thereby determining, for each virtual account, resource output that was generated due to the event. Such aspects may thus enable the determination of resource output generation without necessarily processing individual user elections corresponding to the event. Accordingly, resource output for the event is allocated and subsequently processed (e.g., to generate another resource grant) based on a proportion of resource units that were on-loan or available for grant to another user/virtual account as of the entitlement date.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for outturn-based resource allocation according to aspects described herein.

FIG. 2 illustrates an overview of an example method for outturn-based resource allocation according to aspects described herein.

FIG. 3 illustrates an overview of an example method for generating a resource allocation, which may be used as part of the outturn-based resource allocation techniques described herein.

FIG. 4 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a first user (e.g., a resource lender) grants access for a resource (e.g., as may reside or otherwise be associated with the first user's virtual account) to a second user (e.g., a resource borrower). As a result of borrowing the resource, the second user may thus be entitled to various permissions and/or benefits associated with the resource, such as receiving output that is generated in association with the resource while the resource is loaned to the second user. However, in some examples, the first user may still be entitled to receive any of a variety of benefits associated with the loaned resource (e.g., as may be similar to and/or different from those to which the second user is entitled) and/or to perform any of a variety of associated actions (e.g., to elect an output for the resource and/or to indicate one or more preferences). Thus, output and/or actions corresponding to a loaned resource (e.g., each of which may be associated with one or more events) may be managed accordingly.

However, managing resources may be challenging, especially in instances where a user election affects the resulting output for a resource, as well as in instances where the resource is managed for multiple users, each of which may make a different election. In such examples, each user election may be processed to determine an output for the associated resource. However, processing each election (e.g., individually) may result in high computational resource utilization, which may introduce processing delays and/or reduce the throughput of events that may be processed, among other detriments. As another example, processing each election may affect scalability and may thus make it difficult or impossible to manage an increasing number of users, resources, and/or accounts. Aspects of the present disclosure therefore aim to address these and other technical problems relating to event processing, resource management, and resource output allocation, among other examples.

Accordingly, aspects of the present disclosure relate to outturn-based resource allocation. In examples, an indication of an event is received. For example, the event is associated with the generation of resource output (e.g., as may occur as a result of a user election). In examples, the event has an entitlement date and a generation date (e.g., on which the resource output is generated). Examples of an entitlement date include, but are not limited to, a record date, a deadline date, or other date on which the set of virtual accounts are determined for which resource output corresponding to a given event will be generated. A set of virtual accounts with which the resource was associated on the entitlement date is determined, which are thus entitled to the resource output that is generated on the generation date. In examples, resource information is determined for each virtual account of the set of virtual accounts, which indicates units of the resource that were on-loan or available for grant by the virtual account on the entitlement date. Additionally, changed resource information associated with the generation date (e.g., between the generation date and a date prior to the generation date) is evaluated for each of the determined virtual accounts, thereby determining the resource output that was generated as a result of the event for each virtual account. In examples, the resource information is evaluated net of intervening transactions that are associated with the resource (e.g., as may have inadvertently been included in the changed resource information), thereby correctly identifying a change to the units of the resource for a given virtual account that is due to resource output generation for the event. Accordingly, resource output for the event is allocated and subsequently processed (e.g., to generate another resource grant in instances where the resource output results in an increase in resource units) based on the proportion of the resource units for the given virtual account that were on-loan or available for grant as of the entitlement date.

Aspects of the present disclosure may be used in conjunction with any of a variety of resources, including, but not limited to, computing resources, physical resources, and/or financial resources, such as stocks or other instruments. As an example, a resource is a computing resource (e.g., processor time, storage in a datastore, and/or storage in computer memory), which may be indicated by a user as being available for lending (e.g., to one or more other users) according to aspects described herein. For instance, the user may indicate that one or more idle or unused computing resources are usable by one or more other users, for example to be used in encoding/transcoding streaming content and/or to function as part of a distributed system, among other examples. Accordingly, as a result of an idle computing resource of the user being used by another user, a participation metric is generated for the user according to aspects of the present disclosure (e.g., as compared to other users that have contributed idle computing resources to the pool of computing resources). Thus, the participation metric is used to allocate a future workload (such that a user having a comparatively more favorable participation metric receives a higher allocation of the future workload) and/or to distribute a resource among the set of users accordingly (e.g., as a “universal” issue of the resource to all users), among other examples.

For instance, if it is determined that the computing resources of the user successfully contributed to the computing capabilities of the pool of computing resources (e.g., having uptime above a predetermined threshold and/or having latency below a predetermined threshold), a participation metric allocated to the user thus reflects the user's positive involvement in the pool of computing resources. By contrast, if it is determined that the user's computing resources were detrimental to the operation of the pool of computing resources (e.g., having uptime below a predetermined threshold and/or having latency above a predetermined threshold), the allocated participation metric thus reflects the user's negative involvement. While an example is described in which a single participation metric results in a resource increase or a resource decrease (e.g., depending on whether the user's computational resource(s) result(s) in a positive effect or a negative effect, respectively, on the pool of computing resources), it will be appreciated that similar techniques may be used to generate both a positive participation metric and a negative participation metric, where both metrics are updated based on a corresponding allocation accordingly (e.g., the user's positive participation metric accrues on positive performance and the user's negative participation metric accrues on negative performance).

As another example, a resource is a digital asset or a tokenized asset (e.g., an off-chain resource represented as a token) on a distributed ledger (e.g., a blockchain or other network). In some instances, the distributed ledger is hierarchical (e.g., having multiple layers and/or nodes). A resource generation event (e.g., an “airdrop” or resource output corresponding to a smart contract) results in resource output associated with the resource, which may thus be allocated to virtual accounts that hold the resource (e.g., to one or more wallets, as of an entitlement date) according to aspects described herein.

For instance, resource generation output is determined at a node in the network that is hierarchically higher than one or more nodes at which resource output will be received (e.g., one or more underlying nodes). As an example, a smart contract within the network operates according to aspects of the present disclosure to automatically allocate resource output to underlying nodes and, thus, wallets/virtual accounts associated therewith. The smart contract may automatically allocate resource output (e.g., as a result of an occurrence of an event) and/or may do so in response to an indication provided by an issuer, among other examples. For instance, the smart contract performs resource allocation for an event corresponding to a digital asset of the distributed ledger. As another example, the issuer allocates resource output to a set of nodes according to aspects described herein.

Additionally, or alternatively, an indication of an event associated with an off-chain resource (e.g., a tokenized asset) is provided to or otherwise obtained by the smart contract, such that the smart contract allocates resource output for the event of the off-chain resource accordingly. As an example, an indication is provided to the smart contract as to a record date, an entitlement date, and/or a set of resources/elections that are associated therewith, among other examples. Thus, the digital ledger may include an indication as to resource ownership (e.g., which wallets have an associated resource and/or which resource units of a wallet are available for grant or have been granted to another user), while resource output generation may occur outside of the network, as may be the case for an off-chain resource. It will be appreciated that similar techniques may be used in instances where a blockchain is not hierarchical. Thus, as noted below, the disclosed aspects may be applied according to any of a variety of paradigms.

As a further example, a virtual account of a user (e.g., an individual, a company, or other entity) may include any number of units (e.g., shares) of a given stock resource, such that at least a subset of the units are indicated by the user as available for lending (e.g., to one or more other users). Accordingly, as a result of an event that generates resource output (e.g., a dividend and/or a change in shares of a resource), the virtual account may receive any number of additional units of the stock resource. In examples, the additional units may thus further be available for lending, such that they are allocated and lent accordingly as a result of aspects described herein, thereby enabling the user to automatically receive additional benefit for lending the additional resource units that resulted from the event. As another example, resource generation output may result in a decreased number of units of the stock resource.

As noted above, resource information may be obtained for a virtual account. In examples, the resource information includes an indication of one or more resources, as well as a corresponding number of units that are associated with the virtual account. In examples, the resource information further includes an indication as to which units of the virtual account are available to be lent to one or more other users. In examples, resource information obtained for a given date (e.g., an entitlement date or a generation date) is obtained as of close of business for the given date, though it will be appreciated that, in other examples, the resource information may additionally or alternatively be obtained for any of a variety of other times (e.g., intraday, premarket, or midnight).

The resource information may be obtained from any of a variety of data sources, including, but not limited to, a data provider, an electronic message (e.g., from a user or a resource manager), and/or a data file (e.g., as may be manually uploaded or received via a secure file transfer protocol), among other examples. For example, resource information that indicates a set of resources and a corresponding amount of units for each resource may be obtained from a resource manager that manages resources and/or a virtual account on behalf of a user. In instances where resource information is aggregated from multiple data sources, the resource information may be normalized or otherwise processed to account for idiosyncrasies or other variability that may exist across the data sources. In some examples, the resource information is stored in a data store, for example in association with a date to which the resource information refers, thereby enabling later retrieval (e.g., for subsequent processing according to aspects described herein).

Similarly, event data may be aggregated from any of a variety of data sources, including, but not limited to, a data provider, an electronic communication, and/or a data file, among other examples. As noted above, an event may be associated with the generation of resource output (which may result in an increase or a decrease of associated resource units) and/or the opportunity for an associated user to express a preference associated with the resource, among other examples. In some instances, a user makes an election associated with an event, for example to elect to receive any number of additional units of a resource, to receive a different resource, to reduce a number of resource units (e.g., as may be the case for a delisting event with respect to a given asset or when a resource unit is exchanged for another resource), or any combination thereof. In examples, event data is aggregated from multiple data sources, for example to mitigate instances where event data that is obtained from a single data source may have reduced accuracy and/or coverage. In such examples, event data that is aggregated from multiple data sources may be deduplicated, normalized, or otherwise processed to account for idiosyncrasies or other variability that may exist across the data sources. The event data may thus be used to generate an event record that is associated with a corresponding resource (e.g., in a data store). As noted above, the event record may include an indication as to an associated entitlement date and/or generation date, among other examples.

While example events are described, it will be appreciated that any of a variety of additional or alternative events may be processed according to aspects described herein. For example, as compared to other processing techniques (e.g., that specifically evaluate event elections at an underlying user account level), aspects of the present disclosure identify resource output generation based on associated changes in resource information. Such aspects may thus result in more performant processing of events and may yield a set of resource allocations that can be applied subsequently to generated resource output, in order to allocate the change in resources accordingly.

Additionally, it will be appreciated that the disclosed techniques may be implemented according to any of a variety of paradigms. For example, a resource allocation platform may implement the disclosed aspects, such that the resource allocation platform obtains resource information and event data, which is used to generate a set of resource allocations for a given event accordingly. The resource allocation platform may be a service (e.g., via a provided application programming interface or “API”) that is accessed by other computing devices (e.g., of a resource manager and/or an event processor) to determine a set of resource allocations accordingly. As another example, aspects of the present disclosure may additionally, or alternatively, be implemented by an event processor (e.g., that performs processing associated with an event to generate one or more units of a resource according to an associated generation date). Thus, rather than communicating with a resource allocation platform, the event processor may instead use the disclosed aspects to allocate generated resource output accordingly.

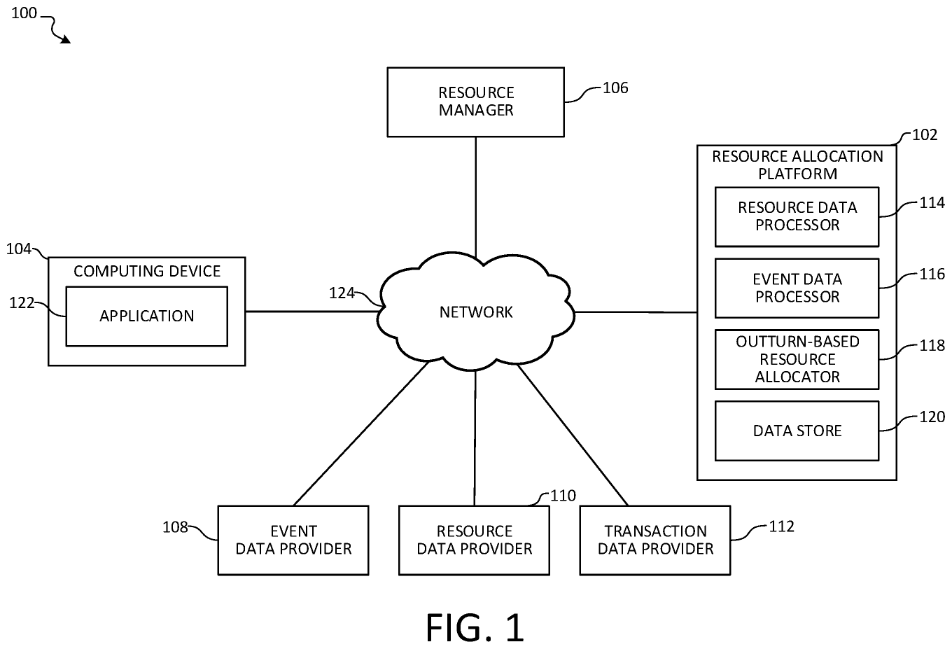

FIG. 1 illustrates an overview of an example system 100 for outturn-based resource allocation according to aspects described herein. As illustrated, system 100 comprises resource allocation platform 102, computing device 104, resource manager 106, event data provider 108, resource data provider 110, transaction data provider 112, and network 124. In examples, resource allocation platform 102, computing device 104, resource manager 106, event data provider 108, resource data provider 110, and/or transaction data provider 112 communicate via network 124. For example, network 124 may comprise a local area network, a wireless network, or the Internet, or any combination thereof, among other examples.

As illustrated, resource allocation platform 102 includes resource data processor 114, event data processor 116, outturn-based resource allocator 118, and data store 120. In examples, resource data processor 114 obtains resource information corresponding to one or more resources of a set of virtual accounts (e.g., as may be managed by resource manager 106). For example, the resource information is obtained from resource manager 106 and/or resource data provider 110. Additionally, or alternatively, resource data processor 114 obtains resource information from an electronic communication and/or a data file (e.g., as may be manually uploaded to resource allocation platform 102 or received via a secure file transfer protocol), among other examples. It will therefore be appreciated that resource information may be obtained from any of a variety of data sources.

As an example, the resource information includes an indication as to a set of resources and a corresponding amount of units associated with a virtual account. In examples, the resource information further comprises an indication as to an amount of units that are available for grant/loan (and/or have been granted/loaned) to one or more other users. Resource data processor 114 may obtain resource information for a virtual account as of a given date, which may be stored in data store 120 in association with the date, thereby enabling subsequent retrieval. For example, a snapshot of the resource information may be generated as of close of business (and/or any of a variety of other times) for a variety of dates, such that relevant resource information for an event (e.g., having an entitlement date and a generation date) may be identified from data store 120 and used for subsequent processing according to aspects described herein.

While examples are described in which resource information snapshots are stored in data store 120, it will be appreciated that any of a variety of additional or alternative techniques may be used to obtain resource information associated with a given date. For example, resource manager 106 may maintain historical account information that includes changes to resources and/or associated units for a given virtual account. As another example, resource manager 106 may additionally, or alternatively, maintain historical account information that includes a set of resources and an indication of associated units for a given date (e.g., as of close of business, at the start of the date, or at the end of the date). Accordingly, such historical account information may be obtained by resource allocation platform 102 to perform processing according to aspects described herein, in addition to, or as an alternative to, snapshots that are stored by data store 120.

Resource allocation platform 102 is further illustrated as comprising event data processor 116. In examples, event data processor 116 aggregates event data from any of a variety of data sources, including, but not limited to, event data provider 108, an electronic communication, and/or a data file, among other examples. As an example, event data provider 108 may be a service that monitors or otherwise collects corporate events for one or more resources. As another example, event data provider 108 may be associated with a resource for which it provides event data, as may be the case for a provider of a financial instrument and/or an exchange, among other examples. It will therefore be appreciated that event data may be obtained from any of a variety of sources.

Event data processor 116 may deduplicate, normalize, and/or otherwise process obtained event data to generate an event record corresponding to an event. In examples, the event record includes an association with a resource to which the event relates, an entitlement date, and a generation date. Generated event records may be stored in data store 120, thereby enabling subsequent retrieval for processing according to aspects described herein.

Resource allocation platform 102 is further illustrated as comprising outturn-based resource allocator 118. In examples, outturn-based resource allocator 118 generates a snapshot for record information corresponding to an entitlement date of an event (e.g., based on an event record, as may have been generated by event data processor 116). For example, a snapshot (e.g., from data store 120) may enable outturn-based resource allocator 118 to determine a set of virtual accounts associated with the resource and a proportion of units that were on-loan or available for grant as of the entitlement date.

In examples, outturn-based resource allocator 118 receives a confirmation or other indication of an event (e.g., on or after the generation date), such that outturn-based resource allocator 118 allocates generated resource output of the event according to aspects described herein. For example, outturn-based resource allocator 118 evaluates resource information for the set of virtual accounts as of the generation date and the date prior to the generation date to determine generated resource output corresponding to the event, thereby determining a change in resource units associated with the event. The change in resource units is also referred to herein as changed resource information. While examples are described in which the evaluation is performed with respect to the generation date and the date prior to the generation date, it will be appreciated that changed resource information may be determined according to any of a variety of other evaluations, including, but not limited to, the start of day on the generation date as compared to the end of day on the generation date or the start of day on the generation date as compared to the start of day on the day after the generation date. Thus, changed resource information may be determined based on resource information before and after processing associated with the event is performed (e.g., as may be performed by a resource manager). In examples, outturn-based resource allocator 118 obtains transaction information (e.g., from transaction data provider 112 and/or resource manager 106, among other data sources), which is used to omit or otherwise account for transactions (e.g., yielding additional or fewer units of the resource for a given virtual account) associated with the resource that would introduce a change to the resource units other than resulted from the event (e.g., between the evaluated dates).

As a result of the evaluation, outturn-based resource allocator 118 thus determines the resource generation output of the event for the set of virtual accounts associated with the resource. Accordingly, outturn-based resource allocator 118 compares the determined resource generation output for the generation date to the resource information for the entitlement date, thereby determining the degree to which each virtual account participated in the event. As an example, for a given virtual account, the determined resource generation output for the virtual account as compared to an amount of units as of the entitlement date may thus yield a participation factor metric of the virtual account for the event.

In order to determine resource generation output for the event to be allocated for subsequent grant/loan (e.g., to one or more other users), outturn-based resource allocator 118 processes the participation factor metric for each respective virtual account based on the proportion of units of the virtual account that were available for loan as of the entitlement date, thereby generating an allocation metric for each given virtual account. In examples, an allocation ratio metric is generated for each of the virtual accounts, where the resource allocation ratio metric for a given virtual account is a proportion of the allocation metric for the virtual account to the total allocation metrics for the set of virtual accounts.

In examples, outturn-based resource allocator 118 allocates generated resource output to each of the virtual accounts based on a corresponding allocation ratio metric for the given virtual account according to aspects described herein. In other examples, an indication of the set of allocation ratio metrics is provided to another computing device (e.g., resource manager 106), such that the computing device allocates generated resource output according to the allocation ratio metrics accordingly. In examples, access to one or more units of the resource generation output is granted to one or more other users according to the generated resource allocation ratio metric for a given virtual account. It will therefore be appreciated that any of a variety of additional or alternative processing may be performed using a set of allocation ratio metrics.

In examples, a user changes an amount of units that are available for loan between an entitlement date and a generation date, such that a generated set of resource allocation ratio metrics may include an allocation corresponding to such opted-out resource units. Accordingly, if outturn-based resource allocator 118 is able to obtain current resource information (e.g., as of the generation date), outturn-based resource allocator 118 may dynamically adjust the generated set of resource allocation ratio metrics, for example to distribute opted-out units of resource generation output among users/virtual accounts that still have resource units available for loan. In examples, such opted-out units are allocated to one or more virtual accounts that have since opted-in after the entitlement date. It will be appreciated that any of a variety of other techniques may be used to allocate such units, for example according to a priority queue or based on a third-party preference indication, among other examples. Such allocations may be made to virtual accounts that were opted-in prior to the entitlement date, virtual accounts that opted-in after the entitlement date, or any combination thereof. As another example, an opted-out unit is allocated to a separate virtual account, which may be referred to herein as an “excess account.”

System 100 is further illustrated as comprising computing device 104, which includes application 122. In examples, application 122 is a web browser, a native application, or any of a variety of other applications. A user of computing device 104 uses application 122 to access data from or otherwise associated with resource allocation platform 102. For example, a user having a virtual account that includes one or more resource units that are available for loan may use application 122 to view an allocated amount of units for resource generation output that resulted from an event. In examples, the allocated amount of units was determined be outturn-based resource allocator 118 according to aspects described herein. Additionally, or alternatively, application 122 is used to indicate additional or fewer units as being available for loan to one or more other users and/or to transfer resource units to other users/virtual accounts, among other examples. As a further example, application 122 is used to search for a specific event, such that one or more allocation metrics are obtained for display to the user (e.g., as may be organized by client and/or virtual account). In some examples, allocation metrics may be exported for audit purposes.

While system 100 is described with reference to specific data sources (e.g., resource manager 106, event data provider 108, resource data provider 110, and transaction data provider 112), it will be appreciated that data may be obtained from any of a variety of additional or alternative sources in other examples. Additionally, system 100 illustrates an example paradigm in which resource allocation platform 102 includes the functionality discussed above with respect to resource data processor 114, event data processor 116, outturn-based resource allocator 118, and data store 120. It will be appreciated that such functionality may be distributed according to any of a variety of other paradigms, for example such that resource manager 106 additionally, or alternatively, implements at least a part of such functionality.

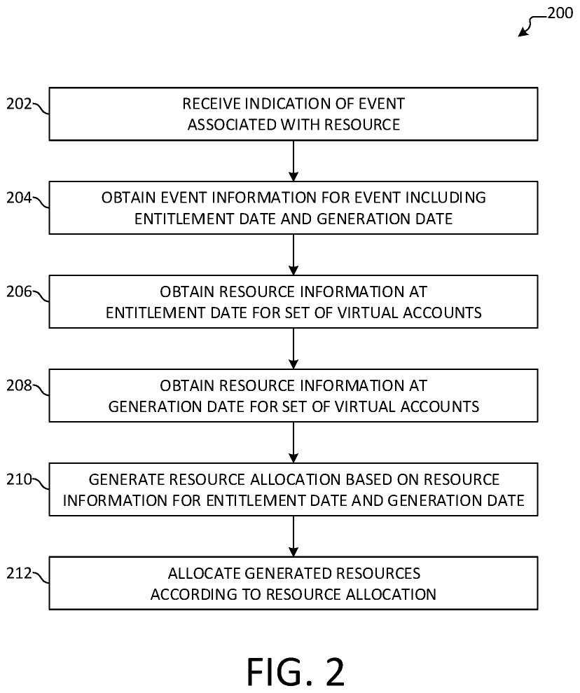

FIG. 2 illustrates an overview of an example method 200 for outturn-based resource allocation according to aspects described herein. In examples, aspects of method 200 are performed by a resource allocation platform, such as resource allocation platform 102 in FIG. 1.

As illustrated, method 200 begins at operation 202, where an indication of an event associated with a resource is received. In examples, the indication is received from an event data provider, such as event data provider 108 in FIG. 1. As noted above, the event may be associated with the generation of resource output and/or may include an opportunity for a user having one or more units of the resource to perform any of a variety of associated actions (e.g., to elect an output for the resource and/or to indicate one or more preferences).

Accordingly, at operation 204, event information for the event is obtained, as may include an entitlement date for the event and a generation date for the event, among other examples. In examples, aspects of operation 204 are performed by an event data processor, such as event data processor 116 discussed above with respect to FIG. 1. In some instances, the indication that was received at operation 202 includes such event information. In other examples, operation 204 includes obtaining the event information from a data store or a third-party data source, among other examples. It will therefore be appreciated that the event information may be obtained from any of a variety of data sources.

Flow progresses to operation 206, where resource information is obtained for a set of virtual accounts as of the entitlement date for the event. In examples, aspects of operation 206 are performed by a resource data processor, such as resource data processor 114 discussed above with respect to FIG. 1. For instance, the resource information is obtained from a resource manager (e.g., resource manager 106 in FIG. 1), from a resource data provider (e.g., resource data provider 110), and/or as a snapshot from a data store (e.g., data store 120), among other examples. As noted above, the resource information includes an indication of one or more resources associated with each given virtual account, a number of units for one or more resources of the virtual account, and/or an indication of one or more resource units that are available for loan to one or more other users/virtual accounts.

At operation 208, resource information is obtained as of the generation date for the event. In examples, aspects of operation 208 are performed by a resource data processor, such as resource data processor 114 discussed above with respect to FIG. 1. Aspects of operation 208 are similar to those discussed above with respect to operation 206 and are therefore not necessarily redescribed in detail. It will be appreciated that, in some examples, resource information obtained at operations 206 and 208 may be obtained from different sources, as may be the case when historical resource information is stored by a data store (e.g., such that resource information associated with an entitlement date, which has since passed, is stored as a snapshot by the data store). By contrast, operation 208 may include obtaining the resource information from a resource manager and/or resource data provider, as the generation date may be upcoming or may have only recently passed, among other examples.

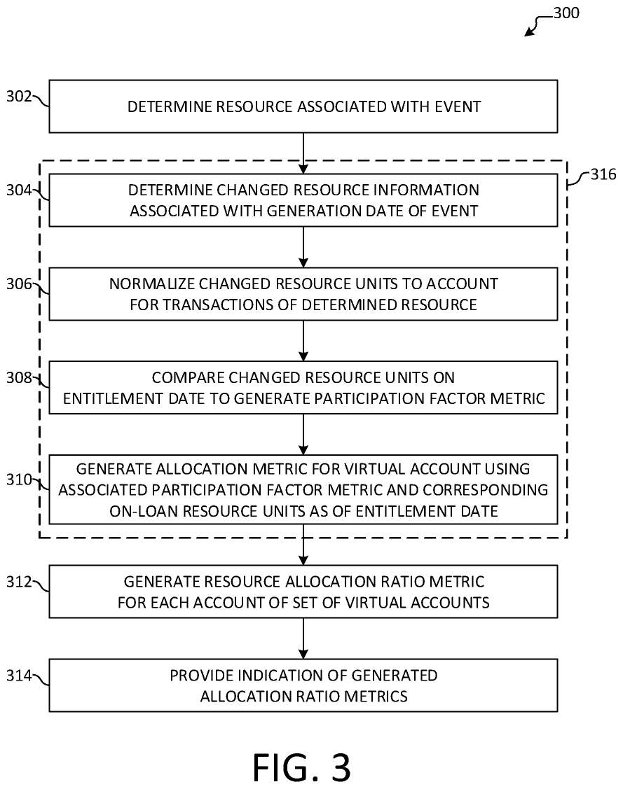

Moving to operation 210, a set of resource allocation ratio metrics is generated for the set of virtual accounts based on the resource information that was obtained for the entitlement date and the generation date. In examples, aspects of operation 210 are performed by an outturn-based resource allocator, such as outturn-based resource allocator 118 discussed above with respect to FIG. 1. The resulting set of resource allocation ratio metrics may indicate a proportion of generated resource allocation output to allocate to each virtual account of the set of virtual accounts, aspects of which were discussed above with respect to outturn-based resource allocator 118. Additional examples of the aspects that may be performed as part of operation 210 are discussed below with respect to method 300 of FIG. 3.

At operation 212, generated resource output associated with the event is allocated according to the set of resource allocation ratio metrics that was generated at operation 210. In examples, operation 212 comprises providing an indication of the set of resource allocation ratio metrics to a resource manager (e.g., resource manager 106 in FIG. 1) or other third party, such that the third party allocates the generated resource output of the event accordingly. In other examples, operation 212 comprises updating at least a subset of the virtual accounts to allocate the generated resource output to each virtual account accordingly. In some instances, operation 212 further comprises enabling one or more units of the allocated resource generation output to be borrowed accordingly (e.g., by another user/virtual account). Method 200 terminates at operation 212.

FIG. 3 illustrates an overview of an example method 300 for generating a resource allocation, which may be used as part of the outturn-based resource allocation techniques described herein. In examples, aspects of method 300 are performed by an outturn-based resource allocator, such as outturn-based resource allocator 118 in FIG. 1. Aspects of method 300 may be performed as part of operation 210 discussed above with respect to method 200 of FIG. 2.

As illustrated, method 300 begins at operation 302, where a resource associated with an event is determined. In some examples, the determined resource and the resource for which the event was generated need not be the same resource, as may be the case when the event results in resource generation output for a resource that is different that the resource for which the event occurred. In examples, operation 302 comprises evaluating event information, as may be obtained from an event data provider (e.g., event data provider 108 in FIG. 1) and/or a data store (e.g., data store 120), among other examples. As noted above, the event has an associated entitlement date and an associated resource generation date, among other examples.

Flow progresses to operation 304, where changed resource information associated with the generation date of the event is determined. As noted above, the changed resource information may be determined based on resource information for the generation date and a date prior to the generation date or based on resource information at the beginning of the generation date as compared to resource information at the end of the generation date, among other examples. As an example, a change in units of a resource corresponding to the event is determined at operation 304, at least a part of which may be generated resource output that resulted from the event itself. In some examples, at least a part of the change in units is due to a transaction associated with the resource, for example as a result of a user transferring units to or from another user and/or virtual account, among other examples. Aspects of operation 304 may be performed based on resource information, as may be obtained from a resource data provider (e.g., resource data provider 110 in FIG. 1), a resource manager (e.g., resource manager 106), and/or as a snapshot of historical resource information from a data store (e.g., data store 120), among other examples.

Accordingly, at operation 306, the change in resource units is normalized to omit or otherwise account for a change other than resource generation output for the event. For example, transaction data associated with the virtual account and/or resource may be obtained (e.g., from a transaction data provider, such as transaction data provider 112 in FIG. 1) and processed to identify intervening changes to units of a resource for the virtual account that occurred separate from resource generation output for the event. While example processing and associated data sources are described herein, it will be appreciated that any of a variety of other techniques may be used to determine whether at least a portion to a change in resource units of a virtual account corresponds to an event or one or more other intervening factors.

Moving to operation 308, the normalized changed resource units generated at operation 306 are compared to resource units of the given virtual account as of the entitlement date, thereby generating a participation factor metric for the virtual account. As discussed above, the normalized changed resource units indicate resource generation output for the given virtual account that resulted from the occurrence of the event. Accordingly, the participation factor metric generated at operation 308 relates the determined resource generation output for the virtual account to an amount of resource units for the given virtual account as of the entitlement date.

Flow progresses to operation 310, where an allocation metric is generated for the given virtual account using the participation factor metric and an amount of resource units that were available for loan as of the entitlement date. As an example, the product of the participation factor metric and the amount of resource units that were available for loan as of the entitlement date may thus yield an allocation metric for the virtual account according to aspects described herein. Thus, it will be appreciated that the allocation metric for the virtual account indicates an amount of on-loan or grantable resource units for which resource output was generated as a result of the event (e.g., according to a user election).

Dashed box 316 is illustrated around operations 304, 306, 308, and 310 to indicate that, in examples, such aspects are performed for each virtual account of a set of virtual accounts, such that a resource allocation metric is generated for each virtual account accordingly. Thus, operations 304, 306, 308, and 310 may yield a set of resource allocation metrics, where each resource allocation metric corresponds to a virtual account.

Accordingly, at operation 312, a resource allocation ratio metric is generated for each virtual account of the set of virtual accounts, where the resource allocation ratio metric for a given virtual account indicates a proportion of the resource allocation metric for the given virtual account to a total of the resource allocation metrics for the set of virtual accounts. As noted above, an amount of resource units that are available for loan by a given virtual account may change between an entitlement date and a generation date, such that operation 312 may further comprise dynamically adjusting the resource allocation ratio metrics to account for generated resource output associated with such opted-out units, for example according to other resource units that remain available for loan as of the generation date. It will be appreciated that any of a variety of other techniques may be used to allocate such units, for example according to a priority queue or based on a third-party preference indication, among other examples.

Finally, at operation 314, an indication of the generated resource allocation ratio metrics is provided for subsequent processor. Examples of such aspects were discussed above with respect to operation 212 of method 200 in FIG. 2. For example, generated resource output may be allocated to one or more virtual accounts of the set of virtual accounts according to the set of resource allocation metrics that was generated at operation 312. As another example, an indication of the set of resource allocation metrics is provided to a third party, such that the third party allocates generated resource output accordingly. Method 300 terminates at operation 314.

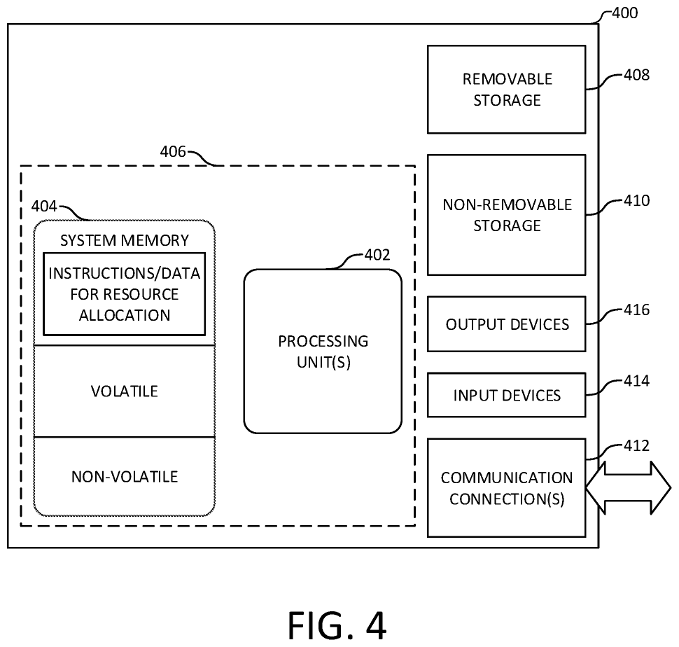

FIG. 4 illustrates an example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically may include at least one processing unit 402 and memory 404. Depending on the exact configuration and type of computing device, memory 404 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as a keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 may include at least some form of computer readable media. The computer readable media may be any available media that can be accessed by processing unit 402 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules (e.g., applications, Input/Output (I/O) management, and other utilities) may perform processes including, but not limited to, one or more of the stages of the operational methods described herein with respect to FIG. 1 and/or such as the methods illustrated in FIG. 2 or 3, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, cause the system to perform a set of operations. The set of operations comprises: obtaining event information for an event associated with a resource, wherein the event information includes an entitlement date and a generation date for the event; determining, based on resource information as of the entitlement date, an amount of units of the resource for a virtual account of a set of virtual accounts; determining changed resource information associated with the event; generating, based on the amount of units as of the entitlement date and the changed resource information, a participation factor metric for the virtual account; generating, for the virtual account and based on the participation factor metric and an amount of units of the virtual account that were available for grant to another virtual account as of the entitlement date, a resource allocation metric of a set of resource allocation metrics; generating, for the virtual account and based on the set of resource allocation metrics for the set of virtual accounts, a resource allocation ratio metric of a set of resource allocation ratio metrics; and providing, for resource allocation of generated resource output corresponding to the event, the set of resource allocation ratio metrics. In an example, the set of operations further comprises: generating a grant for the generated resource output according to the resource allocation ratio metric for the virtual account, thereby allocating at least a part of the generated resource output for grant to one or more other virtual accounts. In another example, the resource information as of the entitlement date is obtained from a first data source; and the resource information as of the generation date is obtained from a second data source that is different than the first data source. In a further example, the first data source includes a snapshot of resource information for the entitlement date. In yet another example, obtaining event information for the event comprises aggregating event information from a plurality of data sources. In a further still example, determining the changed resource information comprises: identifying, based on transaction information from a transaction data provider, a transaction for a unit of the resource; and omitting, from the determined changed resource information, the transaction for the unit of the resource. In another example, generating the resource allocation ratio metric for the virtual account further comprises allocating at least a part of the generated resource output corresponding to an opted-out resource unit to the virtual account.

In another aspect, the technology relates to a method for allocating generated output corresponding to an event for a resource. The method comprises: aggregating, from a plurality of event data providers, event information for an event associated with a resource, wherein the event information includes an entitlement date and a generation date for the event; determining, based on resource information as of the entitlement date from a first data source, an amount of units of the resource for a virtual account of a set of virtual accounts; determining changed resource information associated with the event; generating, based on the amount of units as of the entitlement date and the changed resource information, a participation factor metric for the virtual account; generating, for the virtual account and based on the participation factor metric and an amount of units of the virtual account that were available for grant to another virtual account as of the entitlement date, a resource allocation metric of a set of resource allocation metrics; generating, for the virtual account and based on the set of resource allocation metrics for the set of virtual accounts, a resource allocation ratio metric of a set of resource allocation ratio metrics; and providing, for resource allocation of generated resource output corresponding to the event, the set of resource allocation ratio metrics. In an example, the method further comprises: generating a grant for the generated resource output according to the resource allocation ratio metric for the virtual account, thereby allocating at least a part of the generated resource output for grant to one or more other virtual accounts. In another example, the second data source is different than the first data source. In a further example, the first data source includes a snapshot of resource information for the entitlement date. In yet another example, determining the changed resource information comprises: identifying, based on transaction information from a transaction data provider, a transaction for a unit of the resource; and omitting, from the determined changed resource information, the transaction for the unit of the resource. In a further still example, generating the resource allocation ratio metric for the virtual account further comprises allocating at least a part of the generated resource output corresponding to an opted-out resource unit to the virtual account.

In a further aspect, the technology relates to a method for allocating generated output corresponding to an event for a resource. The method comprises: obtaining event information for an event associated with a resource, wherein the event information includes an entitlement date and a generation date for the event; determining, based on resource information as of the entitlement date, an amount of units of the resource for a virtual account of a set of virtual accounts; determining changed resource information associated with the event; generating, based on the amount of units as of the entitlement date and the changed resource information, a participation factor metric for the virtual account; generating, for the virtual account and based on the participation factor metric and an amount of units of the virtual account that were available for grant to another virtual account as of the entitlement date, a resource allocation metric of a set of resource allocation metrics; generating, for the virtual account and based on the set of resource allocation metrics for the set of virtual accounts, a resource allocation ratio metric of a set of resource allocation ratio metrics; and providing, for resource allocation of generated resource output corresponding to the event, the set of resource allocation ratio metrics. In an example, generating a grant for the generated resource output according to the resource allocation ratio metric for the virtual account, thereby allocating at least a part of the generated resource output for grant to one or more other virtual accounts. In another example, the resource information as of the entitlement date is obtained from a first data source; and the resource information as of the generation date is obtained from a second data source that is different than the first data source. In a further example, the first data source includes a snapshot of resource information for the entitlement date. In yet another example, obtaining event information for the event comprises aggregating event information from a plurality of data sources. In a further still example, determining the changed resource information comprises: identifying, based on transaction information from a transaction data provider, a transaction for a unit of the resource; and omitting, from the determined changed resource information, the transaction for the unit of the resource. In another example, generating the resource allocation ratio metric for the virtual account further comprises allocating at least a part of the generated resource output corresponding to an opted-out resource unit to the virtual account.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining event information for an event associated with a resource, wherein the event information includes an entitlement date and a generation date for the event;
determining, based on resource information as of the entitlement date, an amount of units of the resource for a virtual account of a set of virtual accounts;
determining changed resource information associated with the event;
generating, based on the amount of units as of the entitlement date and the changed resource information, a participation factor metric for the virtual account;
generating, for the virtual account and based on the participation factor metric and an amount of units of the virtual account that were available for grant to another virtual account as of the entitlement date, a resource allocation metric of a set of resource allocation metrics;
generating, for the virtual account and based on the set of resource allocation metrics for the set of virtual accounts, a resource allocation ratio metric of a set of resource allocation ratio metrics; and
providing, for resource allocation of generated resource output corresponding to the event, the set of resource allocation ratio metrics.

2. The system of claim 1, wherein the set of operations further comprises:
generating a grant for the generated resource output according to the resource allocation ratio metric for the virtual account, thereby allocating at least a part of the generated resource output for grant to one or more other virtual accounts.

3. The system of claim 1, wherein:
the resource information as of the entitlement date is obtained from a first data source; and
the resource information as of the generation date is obtained from a second data source that is different than the first data source.

4. The system of claim 3, wherein the first data source includes a snapshot of resource information for the entitlement date.

5. The system of claim 1, wherein obtaining event information for the event comprises aggregating event information from a plurality of data sources.

6. The system of claim 1, wherein determining the changed resource information comprises:
identifying, based on transaction information from a transaction data provider, a transaction for a unit of the resource; and
omitting, from the determined changed resource information, the transaction for the unit of the resource.

7. The system of claim 1, wherein generating the resource allocation ratio metric for the virtual account further comprises allocating at least a part of the generated resource output corresponding to an opted-out resource unit to the virtual account.

8. A method for allocating generated output corresponding to an event for a resource, the method comprising:
aggregating, from a plurality of event data providers, event information for an event associated with a resource, wherein the event information includes an entitlement date and a generation date for the event;
determining, based on resource information as of the entitlement date from a first data source, an amount of units of the resource for a virtual account of a set of virtual accounts;
determining changed resource information associated with the event;
generating, based on the amount of units as of the entitlement date and the changed resource information, a participation factor metric for the virtual account;
generating, for the virtual account and based on the participation factor metric and an amount of units of the virtual account that were available for grant to another virtual account as of the entitlement date, a resource allocation metric of a set of resource allocation metrics;
generating, for the virtual account and based on the set of resource allocation metrics for the set of virtual accounts, a resource allocation ratio metric of a set of resource allocation ratio metrics; and
providing, for resource allocation of generated resource output corresponding to the event, the set of resource allocation ratio metrics.

9. The method of claim 8, further comprising:
generating a grant for the generated resource output according to the resource allocation ratio metric for the virtual account, thereby allocating at least a part of the generated resource output for grant to one or more other virtual accounts.

10. The method of claim 8, wherein the second data source is different than the first data source.

11. The method of claim 10, wherein the first data source includes a snapshot of resource information for the entitlement date.

12. The method of claim 8, wherein determining the changed resource information comprises:
identifying, based on transaction information from a transaction data provider, a transaction for a unit of the resource; and
omitting, from the determined changed resource information, the transaction for the unit of the resource.

13. The method of claim 8, wherein generating the resource allocation ratio metric for the virtual account further comprises allocating at least a part of the generated resource output corresponding to an opted-out resource unit to the virtual account.

14. A method for allocating generated output corresponding to an event for a resource, the method comprising:
obtaining event information for an event associated with a resource, wherein the event information includes an entitlement date and a generation date for the event;
determining, based on resource information as of the entitlement date, an amount of units of the resource for a virtual account of a set of virtual accounts;
determining changed resource information associated with the event;
generating, based on the amount of units as of the entitlement date and the changed resource information, a participation factor metric for the virtual account;
generating, for the virtual account and based on the participation factor metric and an amount of units of the virtual account that were available for grant to another virtual account as of the entitlement date, a resource allocation metric of a set of resource allocation metrics;
generating, for the virtual account and based on the set of resource allocation metrics for the set of virtual accounts, a resource allocation ratio metric of a set of resource allocation ratio metrics; and
providing, for resource allocation of generated resource output corresponding to the event, the set of resource allocation ratio metrics.

15. The method of claim 14, further comprising:
generating a grant for the generated resource output according to the resource allocation ratio metric for the virtual account, thereby allocating at least a part of the generated resource output for grant to one or more other virtual accounts.

16. The method of claim 14, wherein:
the resource information as of the entitlement date is obtained from a first data source; and
the resource information as of the generation date is obtained from a second data source that is different than the first data source.

17. The method of claim 16, wherein the first data source includes a snapshot of resource information for the entitlement date.

18. The method of claim 14, wherein obtaining event information for the event comprises aggregating event information from a plurality of data sources.

19. The method of claim 14, wherein determining the changed resource information comprises:
identifying, based on transaction information from a transaction data provider, a transaction for a unit of the resource; and
omitting, from the determined changed resource information, the transaction for the unit of the resource.

20. The method of claim 14, wherein generating the resource allocation ratio metric for the virtual account further comprises allocating at least a part of the generated resource output corresponding to an opted-out resource unit to the virtual account.
